(19) United States
(12) Patent Application Publication
(10) Pub. No.: US 2025/0084520 A1
(43) Pub. Date: Mar. 13, 2025

(54) METHOD FOR APPLYING A PARTIAL COATING

(71) Applicant: JUBO TECHNOLOGIES GMBH, Wuppertal (DE)

(72) Inventors: Ulrich JÜPTNER, HILDEN (DE); Steffen HEICHE, SCHWAIGERN (DE)

(21) Appl. No.: 18/722,381

(22) PCT Filed: Dec. 22, 2022
(86) PCT No.: PCT/EP2022/087448

§ 371 Date: Jun. 20, 2024

(30) Foreign Application Priority Data
Dec. 23, 2021 (DE) 10 2021 134 572.3

(51) Int. Cl. C23C 4/01; C23C 4/10; C23C 4/11; C23C 4/129

(52) U.S. Cl. CPC C23C 4/01; C23C 4/10; C23C 4/11; C23C 4/129

(57) ABSTRACT

A method for applying a partial coating to a metallic substrate including providing a substrate to be coated, inserting the substrate into a reactive area of a thermal source, inserting precursor compounds into the reactive area of the thermal source to produce coating additives, and coating of the substrate through the coating additives produced within the reactive area of the thermal source.

The present invention relates to a method for applying a partial coating, a metallic substrate with an at least partial coating and a coating system for applying a partial coating. In addition, the invention relates to the use of a precursor compound in a method for applying a partial coating.

As part of the expansion of electromobility, particular attention is being paid to the production of battery systems that are installed in so-called battery boxes in high-performance electric vehicles. These boxes are usually fitted with glued-on cooling plates and fitted with elastomer seals or adhesive bonding at the edges and feed-throughs. The battery boxes have dimensions in the range of 2 m² and fill the entire vehicle floor. For efficient heat transfer to a cooling plate, a gap filler or other heat transfer material, such as a heat-conducting paste or similar, is required between the cooling plate and the battery cells. However, high-purity, adhesive surfaces are essential for the application of adhesives or heat transfer pastes. Corrosion protection is also required, as these battery boxes are often installed in the underbody of vehicles and are therefore exposed to corrosive media such as road salt or similar. This means that an untreated metal surface is not suitable for subsequent adhesive bonding or for the application of a heat transfer paste, as untreated surfaces are not very corrosion-resistant and are also too inhomogeneous.

Wet-chemical surface modification methods are used today to enable simple and stable application of adhesives or heat transfer pastes to metal surfaces and at the same time ensure corrosion resistance. In the case of aluminum, for example, so-called aluminum oxyhydrates (boehmites) are required in the surface for adhesive bonding, which are produced using downstream aqueous chemical passivation processes. To improve corrosion stability, aluminum components are commonly provided with a so-called conversion layer in an aqueous process according to the state of the art. Methods for applying such a layer include wet-chemical methods such as anodizing, chromating, phosphating and zirconium/titanium fluoride passivation. Comparable wet-chemical methods for surface functionalization are also known for other metals, such as iron, magnesium or zinc.

However, the disadvantages of the known wet chemical processes for surface functionalization of metal substrates are that these processes often take several hours, are very energy-intensive and require a great deal of technical equipment. In addition, the processes usually have to be mapped to the entire component as bath processes. This is very uneconomical for large components that are only to be partially bonded. In addition, the above-mentioned wet chemical methods are disadvantageous from an environmental point of view, as the rinsing baths must be subjected to wastewater treatment after use in order to neutralize the rinsed chemicals and remove the ingredients from the water by precipitation and flocculation.

In addition to wet-chemical methods for the surface modification of metallic substrates, thermal coating methods are also known from the prior art, in which coating materials are dissolved in organic solvents and mixed with a liquid gas flame to produce a surface modification on a substrate. However, the flexibility with regard to surface modification is limited due to the prior dissolution of the coating materials in the solvents used to generate the flame. The addition of the coating materials is not variable in terms of location, but takes place instantaneously with the combustion of the solvent. In addition, the known thermal coating methods are generally in the form of plasma coating methods, which not only significantly increases the energy consumption but also the equipment required.

It is therefore the object of the present invention to at least partially eliminate the above-mentioned disadvantages of known coating methods for applying a partial coating. In particular, it is the object of the invention to provide a coating method for metallic substrates which enables a targeted partial coating of metallic substrates in a simple, cost-effective, environmentally friendly and flexible manner in order to improve the adhesion of adhesive bonds and elastomer seals and to increase the corrosion resistance of the substrates. It is also desirable for the coating method to be at least partially automatable if possible.

The above problem is solved by a method with the features of the independent method claim, a substrate with the features of the independent material claim, a system with the features of the independent system claim and by a use with the features of the independent use claim. Further features and details of the invention can be seen from the respective dependent claims, the description and the drawings. Features and details which are described in connection with the method according to the invention naturally also apply in connection with the substrate according to the invention, the system according to the invention and the use according to the invention and vice versa, so that reference is or can always be made to the individual aspects of the invention with respect to the disclosure.

According to the invention, a method for applying a partial coating to a metallic substrate is provided. The method according to the invention comprises the stages of providing a substrate to be coated, inserting the substrate into a reactive area of a thermal source, inserting precursor compounds in a targeted manner into the reactive area of the thermal source to produce coating additives and finally coating the substrate through the coating additives produced within the reactive area of the thermal source.

According to the invention, a metallic substrate can be understood in particular as a substrate which is at least partially, preferably completely, formed from a metal material. According to the invention, a partial coating can be understood here in particular as the coating of a part of the surface of a substrate. It is further understood that an insertion of a substrate into a reactive area of a thermal source comprises both the active positioning of a substrate within the reactive area of a thermal source and the active positioning of a thermal source relative to a substrate for inserting the substrate into the reactive area of the thermal source. The targeted insertion of precursor compounds into the reactive area of the thermal source can also advantageously be understood as the targeted localized insertion of the precursor compounds. For example, the precursor compounds can be specifically inserted into different flame regions with different temperatures and/or different oxidation and reduction potentials in order to vary the production of the coating additives in a targeted manner.

The method according to the invention makes it possible in particular to carry out a direct, spatially resolved coating on a substrate. The reactive area can in particular be a flame curtain or part of a flame of a burner. It is also conceivable when using other thermal sources, such as a laser or the like, that a spot of the laser or the spot of the laser beam is regarded as the reactive area. The thermal source can take the form of a laser or a burner, in particular an infrared burner or a near-infrared burner. If the thermal source is configured in the form of a burner, the thermal source can also be configured in the form of a single burner, a surface burner (line burner) or a volume burner (pore burner).

It has been shown that by using the coating method according to the invention, required and desired surface properties can be produced in a new way. In particular, a novel, partially applicable, thermal flame coating process with special aqueous treatment solutions developed for this purpose can be developed as part of the method according to the invention. The partial thermal (flame) coating process described above enables significantly faster and more energy-saving surface functionalization. In addition, the locally flexible insertion of the precursor compounds allows functional properties to be specifically adjusted by adding different chemical substances. Surprisingly, it was also found that partial thermal (flame) coating can be used to deposit firmly adhering layers with very good anti-corrosion properties on various substrates, such as iron, zinc and magnesium. This technology can now be used to change the surface properties of materials in a particularly simple, fast and cost-effective way. Examples include adjusting the surface energy, surface activation and any other chemical and physical changes to the surface.

With regard to good and durable adhesion of the coating to be applied, it may advantageously be provided in accordance with the invention that the substrate is prepared for coating before the substrate to be coated is provided, wherein the preparation comprises cleaning and/or pre-treating the substrate. Cleaning or pre-treatment can include, for example, high-pressure cleaning using air and/or water pressure. Furthermore, the application of a primer or the like may be provided, for example.

With regard to a fast, stable and durable coating of the substrate, it can be provided in particular according to the invention that the coating of the substrate is carried out at a substrate temperature between 0° C. and 800° C., preferably at a substrate temperature between 50° C. and 100° C. In the case of a substrate comprising an aluminum material, a temperature between 100° C. and 200° C. has also proven to be advantageous. The substrate temperature can preferably be varied by the arrangement of the substrate relative to the thermal source, so that the substrate temperature can depend in particular on the proximity and the way in which the thermal source is operated.

As part of a particularly finely tunable control of the coating behaviour, it may advantageously be provided that the targeted insertion of precursor compounds into the reactive area of the thermal source takes place through a dosing device, whereby the precursor compounds are preferably inserted directly from the outside into the reactive area of the thermal source, in particular sprayed in through an atomizing nozzle. The dosed spraying of the precursor compounds preferably prevents turbulent behavior of a flame, which promises a particularly homogeneous coating. In addition, such a dosing device can preferably be positioned flexibly and variably in order to control a coating process as precisely as possible. The dosing device can, for example, take the form of a spraying device, e.g. a compressed air-driven device. The precursor compounds in question can preferably be in a solid state and, for example, suspended in solvents and, together with these, be fed in a targeted manner to a reactive area of a thermal source. However, it is also conceivable in principle that the precursor compounds are present in a liquid or gaseous aggregate state and can be deposited on a substrate.

With regard to a variably controllable coating speed, it can be advantageously provided that the targeted insertion of precursor compounds into the reactive area of the thermal source takes place with the addition of inert gases, with nitrogen and/or argon preferably being used as inert gases. In particular, the addition of the inert gases reduces the number of precursor compounds within a certain volume, which reduces the coating speed somewhat but allows easier processing.

In order to further increase the scope with regard to the setting of desired coating parameters, it is also conceivable that the targeted insertion of precursor compounds into the reactive area of the thermal source takes place with the addition of oxidizing chemicals, with ozone or hydrogen peroxide preferably being used as oxidizing chemicals. Alternatively or cumulatively, perborates, percarbonates, persulphates, peroxodisulphates, perchlorates, chlorates, vanadates, chromium oxides or organic oxidizing agents such as hydrazine, N-oxides, nitroguanidine or corresponding derivatives can also be added.

With regard to increasing the range of desired coating parameters, it is also conceivable that the targeted insertion of precursor compounds into the reactive area of the thermal source can be carried out with the additional addition of further additives, in particular water or colorants. The additional insertion of water makes it possible to specifically modify the coating temperature. The insertion of colorants can also be used, for example, to indicate the coated parts of a substrate. The moisture required for hydrothermal modification can not only be added, but can also come from the combustion itself.

With regard to a high yield of coating additives produced and in the context of a homogeneous coating, it is also conceivable that the precursor compounds are inserted into the reactive area of the thermal source with a particle size of less than 20 μm, preferably 5 μm. When water is added, it is possible to prevent a flame from cooling down as efficiently as possible with a corresponding particle size. In order to generate such a particle size, a standard hydraulic spraying device can be used, for example, which enables very fine atomization.

With regard to a high yield of coating additives produced, in the context of a homogeneous coating and prevention of cooling of a flame in question, it can also be provided according to the invention that the precursor compounds are inserted into the reactive area of the thermal source at an outflow rate of less than 1 g/s, preferably at an outflow rate of less than 0.5 g/s. For this purpose, for example, an atomizing nozzle with a diameter of less than 0.5 mm, preferably less than 0.3 mm, can be provided.

In order to maximize flexibility with regard to the application of coatings to metallic substrates, it may also be advantageous for the coating of the substrate to take the form of partial coating.

Likewise, in the context of great flexibility with regard to the application of coatings to metallic substrates, it can be provided that the coating of the substrate is carried out within the reactive area of the thermal source through the coating additives produced within the reactive area of the thermal source.

In the context of a coating of a metallic substrate that can be adjusted as flexibly and targeted as possible, it can also advantageously be provided according to the invention that the precursor compounds are inserted in liquid form into the reactive area of the thermal source, the precursor compounds preferably being in the form of a solid dissolved in water (H₂O). The precursor compounds can preferably be in the form of aqueous compounds or solutions of metal salts or nanoparticles, preferably inorganic or organometallic compounds of the elements Mg, Ca, Sr, Ba, B, All, Ga, In, Si, Ge, Sn, Pb, Sc, Y, La, Ti, Zr, V, Nb, Ta, Cr, Mo, W, Mn, Re, Fe, Ru, Os, Co, Rh, Ir, Ni, Pd, Pt, Cu, Ag, Au, Zn, Cd, N, P, S. Metal salts or nanoparticles can also be added. Application in liquid form guarantees in particular an exact and precisely adjustable dosage and distribution of the precursor compounds. The use of water as a solvent guarantees, in particular, an environmentally friendly and harmless way of dissolving and applying the precursor compounds.

In addition, the addition of non-aqueous solutions with low oxygen contents, especially in the form of halogenated hydrocarbons, in particular fluorinated hydrocarbons, especially preferably unsaturated hydrocarbons, has also proven to be suitable for forming advantageous substoichiometric compounds with the metal substrate. Furthermore, such substoichiometric compounds (e.g. perovskites) can also be produced with the metal substrate by the application of colloidally dissolved nanoparticles. It is also understood that the insertion of precursor compounds in solid or gaseous form is also conceivable.

As part of a simple and cost-effective implementation of the method in question, it is particularly conceivable that the method is at least partially automated, preferably through a coating robot. It is understood here that, in the context of an automatable version of the method according to the invention, the method can be configured in the form of a computer-implemented method and at least some of the method stages can be carried out automatically, in particular through a computer. Through a coating robot, for example, a substrate can be positioned under computer control within a reactive area of a thermal source or in the vicinity of a reactive area of a thermal source in order to be coated with the coating additives generated within the reactive area of the thermal source via the precursor compounds inserted into the reactive area.

Another object of the invention is a metallic substrate with an at least partial coating, preferably applicable through a method described above, in particular applied through a method described above, comprising a substrate and a coating of coating additives applied to the substrate. The metallic substrate according to the invention thus has the same advantages as those already described in detail in relation to the method according to the invention. The at least partial coating deposited on a metallic substrate by a method according to the invention can in principle have a layer thickness from the nanometer to the millimeter range, preferably a layer thickness of at least 100 nm to 2 mm, in particular a layer thickness of 1 to 500 μm.

In the context of a substrate with multiple uses, it can be provided in particular according to the invention that the metallic substrate is formed from an aluminum material and/or an iron material and/or a zinc material and/or a magnesium material. It is understood that the substrate can also be formed from other metallic construction materials, such as a copper material or a titanium material or the like.

As part of a high degree of flexibility with regard to the application of coatings to metallic substrates, it can also be advantageously provided that the coating is in the form of a partial coating that is only applied to partial areas of a surface of the substrate.

In the context of a particularly advantageous embodiment of the metallic substrate according to the invention, it can also be provided in the present case that the metallic substrate has at least one adhesive bond and/or at least one elastomer seal, the adhesive bond and/or the elastomer seal preferably being arranged directly on the coating, the metallic substrate being configured in particular as a battery box for use in electric vehicles. An adhesive bond can be understood here in particular as an adhesive layer whose adhesion is particularly strong when the substrate is produced using the method according to the invention.

Another object of the invention is a coating system for applying a partial coating to a metallic substrate, in particular for producing a metallic substrate as described above. The coating system comprises a coating chamber for arranging a substrate to be coated, a thermal source for providing a reactive area for producing coating additives from precursor compounds and a dosing device for inserting the precursor compounds into the reactive area.

In the context of an effective and specifically controllable conversion of precursor compounds into coating additives, it may advantageously be provided in particular that the thermal source is in the form of a laser or a burner, in particular an infrared burner or a near-infrared burner.

As part of a particularly effective implementation, it may be provided that the thermal source is in the form of a burner, preferably in the form of a single burner, a surface burner (line burner) or a volume burner (pore burner). Furthermore, it is understood that in addition to the arrangement of one burner, several burners can also be provided next to each other, which can be of the same or different configuration. A volume burner or pore burner in which the flame burns inside a metal mesh or a ceramic sponge has proven to be particularly suitable. The precursor compounds are sprayed directly into the metal mesh or ceramic sponge from the outside. Due to the heat capacity of the metal mesh or ceramic sponge, the temperature of the flame is kept constant even when the precursor compounds are sprayed in, so that the flame does not cool down at any time.

With regard to a high yield of coating additives produced, in the context of a homogeneous coating and prevention of cooling of a flame in question, it can also be provided according to the invention that the dosing device has an atomizing nozzle for finely distributable insertion of precursor compounds into the reactive area, the atomizing nozzle having a diameter of less than 0.5 mm, in particular less than 0.3 mm.

It is also an object of the invention to use a precursor compound in a method described above, wherein the precursor compound is in the form of aqueous compounds of metal salts or nanoparticles, preferably inorganic or organometallic compounds of the elements Mg, Ca, Sr, Ba, B, All, Ga, In, Si, Ge, Sn, Pb, Sc, Y, La, Ti, Zr, V, Nb, Ta, Cr, Mo, W, Mn, Re, Fe, Ru, Os, Co, Rh, Ir, Ni, Pd, Pt, Cu, Ag, Au, Zn, Cd, N, P, S. The precursor compounds can also be formed, for example, in the form of halogenated hydrocarbons, in particular fluorinated hydrocarbons. The use according to the invention thus has the same advantages as those already described in detail with regard to the method according to the invention, the at least partially coated substrate according to the invention and the system according to the invention.

Further advantages, features and details of the invention are shown in the following description, in which embodiments of the invention are described in detail with reference to the drawings. The features mentioned in the claims and in the description may be essential to the invention individually or in any combination.

It shows:

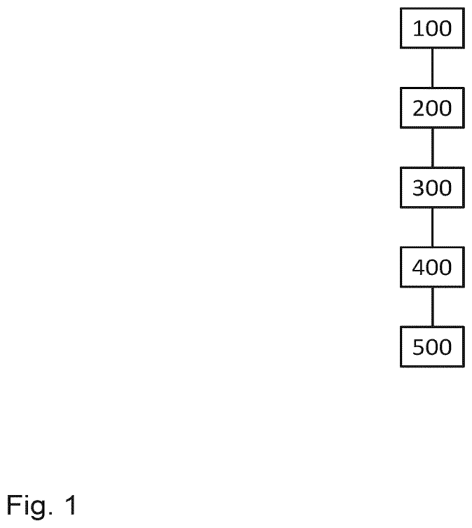

FIG. 1 a schematic representation of the individual stages of a method according to the invention for applying a partial coating to a metallic substrate according to a first embodiment,

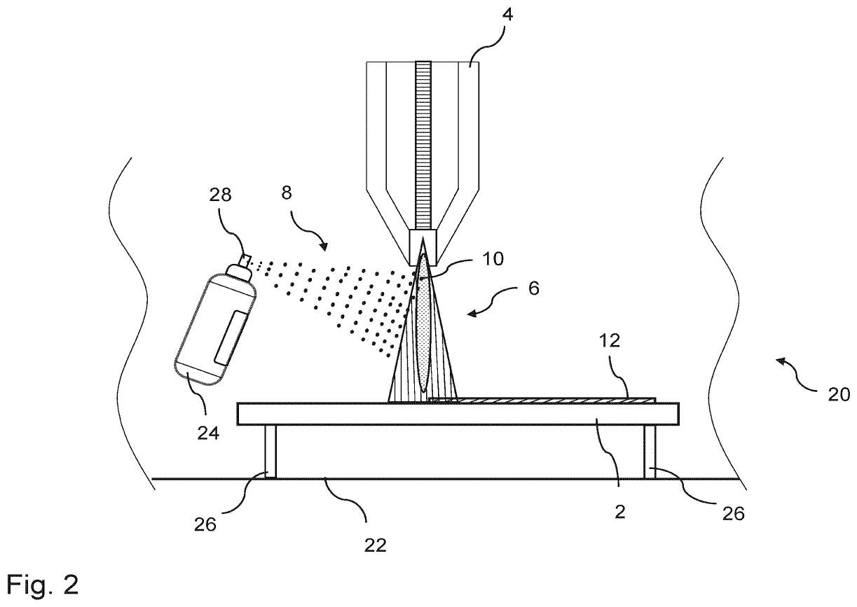

FIG. 2 a schematic representation of a coating system according to the invention for applying a partial coating to a metallic substrate according to a first embodiment,

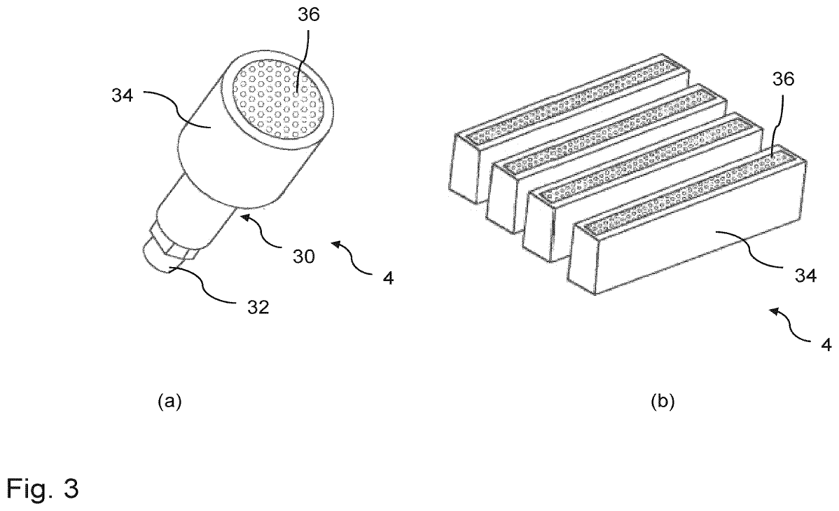

FIG. 3 a schematic representation of a thermal source according to the invention for use in a system according to the invention for applying a partial coating to a metallic substrate according to a second and third embodiment.

FIG. 1 shows a schematic representation of the individual stages of a method according to the invention for applying a partial coating 12 to a metallic substrate 2.

According to the method according to the invention, the substrate 2 is first prepared 100 for the coating 500 of the substrate 2, wherein the preparation 100 preferably comprises cleaning and/or pre-treating the substrate 2.

The substrate 2 to be coated is then provided 200 before the substrate 2 is inserted 300 into a reactive area 6 of a thermal source 4. The insertion of the substrate 2 into a reactive area 6 of the thermal source 4 can comprise both the active positioning of a substrate 2 within the reactive area 6 of the thermal source 4 and the active positioning of the thermal source 4 relative to the substrate 2 in order to insert the substrate 2 into the reactive area 6 of the thermal source.

After an insertion 300 of the substrate 2 into a reactive area 6 of a thermal source 4, a targeted insertion 400 of precursor compounds 8 into the reactive area 6 of the thermal source 4 for the production of coating additives 10 takes place according to the method according to the invention.

The targeted insertion 400 of precursor compounds 8 into the reactive area 6 of the thermal source 4 can preferably be carried out through a dosing device 24, the precursor compounds 8 preferably being inserted directly from the outside into the reactive area 6 of the thermal source 4, in particular being sprayed in through an atomizing nozzle 28.

It may be provided, for example, that the precursor compounds 8 are inserted in liquid form into the reactive area 6 of the thermal source 4, wherein the precursor compounds 8 may preferably be in the form of a solid dissolved in water (H₂O).

The targeted insertion 400 of the precursor compounds 8 into the reactive area 6 of the thermal source 4 can also be carried out alternatively or cumulatively, preferably with the addition of inert gases, with nitrogen and/or argon being used in particular as inert gases.

In addition, the targeted insertion 400 of the precursor compounds 8 into the reactive area 6 of the thermal source 4 can be carried out with the addition of oxidizing chemicals, where ozone or hydrogen peroxide can preferably be used as oxidizing chemicals.

The targeted insertion 400 of the precursor compounds 8 into the reactive area 6 of the thermal source 4 can also be carried out with the addition of further additives, in particular water or colorants.

After the targeted insertion 400 of precursor compounds 8 into the reactive area 6 of the thermal source 4, the substrate 2 is finally coated 500 through the coating additives 10 produced within the reactive area 6 of the thermal source 4.

The coating 500 of the substrate 2 can advantageously be carried out at a substrate temperature between 0° C. and 800° C., preferably at a substrate temperature between 50° C. and 100° C., and in particular in the form of a partial coating. In addition, the coating 500 of the substrate 2 can be carried out within the reactive area 6 of the thermal source 4 through the coating additives 10 produced within the reactive area 6 of the thermal source 4.

FIG. 2 shows a schematic representation of a coating system 20 according to the invention for applying a partial coating 12 to a metallic substrate 2 according to a first embodiment.

As can be seen from FIG. 2, the coating system 20 according to the invention for applying a partial coating 12 to a metallic substrate 2 comprises a coating chamber 22 for arranging a substrate 2 to be coated (in the present case via the retaining elements 26), a thermal source 4 for providing a reactive area 6 for producing coating additives 10 from precursor compounds 8 and a dosing device 24 for inserting the precursor compounds 8 into the reactive area 6 of the thermal source 4.

The thermal source 4 can take the form of a laser or a burner, in particular an infrared burner or a near-infrared burner. In particular, the thermal source 4 can take the form of a single burner, a surface burner or a volume burner.

As can be seen in FIG. 2, the dosing device 24 comprises an atomizing nozzle 28 for the finely distributable insertion of precursor compounds 8 into the reactive area 6, wherein the atomizing nozzle 28 has a diameter of less than 0.5 mm, in particular less than 0.3 mm.

FIG. 3 shows a schematic representation of a thermal source 4 according to the invention for use in a coating system 20 according to the invention for applying a partial coating 12 to a metallic substrate 2 according to a second (a) and third embodiment (b).

According to the second embodiment (a), the thermal source 4 is configured in the form of a piston-shaped single burner, in which the flame guided through the combustion body 34 is led out through the outlet holes 36. The fuel gas required to generate the flame is inserted via the fuel gas inlet 32, whereby fuel air can also be supplied via a combustion air inlet 30.

According to the third embodiment (b), the thermal source 4 is configured in the form of several line burners arranged next to each other, in which the flames guided through the combustion bodies 34 are also led out through the outlet holes 36.

### Examples of Suitable Precursor Compounds:

In the following, some specific embodiments are given as exemplary formulations for precursor compounds for use in a method according to the invention for applying a partial coating to a metallic substrate. As can be seen from the pH values mentioned, the precursor compounds are present in the form of aqueous solutions. It is understood that other solvents can also be used as solvents instead of water.

Solution 1 (solvent H₂O):
1.5 g/l H₂ZrF₆
0.4 g/l SiO₂-nanoparticles
pH 4.7
   Solution 2 (solvent H₂O):
2 g/l H₂TiF₆
0.5 g/l Polyacrylic acid
pH 4.2
   Solution 3 (solvent H₂O):
40 g/l sodium bicarbonate glass
0.5 g/l Ammonium metavanadate
5 g/l Polyisocyanate
0.1 g/l Organic corrosion inhibitors
pH 11.0
   Solution 4 (solvent H₂O):

3.5 g/l H₂ZrF₆
10 g/l Cr(NO₃)₃
pH 2.8
   Solution 5 (solvent H₂O):

5 g/l H₂ZrF₆
10 g/l Cr(NO₃)₃
pH 3.6
   Solution 6 (solvent H₂O):

1.0 g/l H₂ZrF₆
0.06 g/l H₃PO₄
0.5 g/l Maleic acid-acrylic acid copolymer
pH 3.8

### LIST OF REFERENCE SYMBOLS

2 Substrate
4 Thermal source
6 Reactive area
8 Precursor compounds
10 Coating additives
12 Partial coating
20 Coating system
22 Coating chamber
24 Dosing device
26 Retaining elements
28 Atomizing nozzle
30 Combustion air inlet
32 Fuel gas inlet
34 Combustion body
36 Outlet holes
100 Preparation of a substrate
200 Providing of a substrate to be coated
300 Inserting the substrate into a reactive area
400 Targeted insertion of precursor compounds into the reactive area
500 Coating the substrate

1.-22. (canceled)

23. A method of applying a coating to a metallic substrate, comprising:
providing a metallic substrate to be coated,
inserting the metallic substrate into a reactive area of a thermal source,
inserting precursor compounds into the reactive area of the thermal source to produce coating additives, and
coating of the metallic substrate with the coating additives.

24. The method according to claim 23, further comprising, before providing the metallic substrate:
preparing the metallic substrate for coating of the metallic substrate, the preparing comprising at least cleaning or pre-treating the metallic substrate.

25. The method according to claim 23, wherein the coating of the metallic substrate occurs at a substrate temperature between 0° C. and 800° C.

26. The method according to claim 23, wherein the inserting the precursor compounds into the reactive area of the thermal source is through a dosing device.

27. The method according to claim 23, wherein the inserting the precursor compounds into the reactive area of the thermal source comprises adding at least one of: inert gases, oxidizing chemicals, and further additives.

28. The method according to claim 23, wherein the precursor compounds have a particle size of less than 20 μm.

29. The method according to claim 23, wherein the inserting the precursor compounds into the reactive area of the thermal source is performed at an outflow rate of less than 1 g/s.

30. The method according to claim 23, wherein the coating of the metallic substrate is a partial coating.

31. The method according to claim 23, wherein the coating of the metallic substrate is within the reactive area of the thermal source.

32. The method according to claim 23, wherein the inserting the precursor compounds comprises inserting the precursor compounds in liquid form into the reactive area of the thermal source.

33. The method according to claim 23, wherein the method is at least partially automated.

34. A metallic substrate with an at least partial coating, the metallic substrate comprising:
a metallic substrate, and
an at least partial coating including coating additives,
wherein the at least partial coating is applied to the metallic substrate by the method of claim 23.

35. The metallic substrate according to claim 34, wherein the metallic substrate further comprises at least one of: an aluminium material, an iron material, a zinc material, and a magnesium material.

36. The metallic substrate according to claim 34, wherein the at least partial coating is arranged only on partial areas of a surface of the metallic substrate.

37. The metallic substrate according to claim 34, wherein the metallic substrate further comprises at least one adhesive bond or at least one elastomer seal.

38. A coating system for applying a partial coating to a metallic substrate, for producing the metallic substrate according to claim 34, the coating system comprising:
a coating chamber for arrangement of the metallic substrate to be coated,
a thermal source comprising a reactive area for production of the coating additives from precursor compounds, and
a dosing device for inserting the precursor compounds into the reactive area of the thermal source.

39. The coating system according to claim 38, wherein the thermal source is a laser.

40. The coating system according to claim 38, wherein the thermal source is a burner.

41. The coating system according to claim 38, wherein the dosing device comprises an atomizing nozzle for finely distributable insertion of the precursor compounds into the reactive area, the atomizing nozzle having a diameter of less than 0.5 mm.

42. The method according to claim 23, wherein the precursor compounds are in form of aqueous compounds of metal salts or nanoparticles.
